(19) United States
(12) Patent Application Publication
(10) Pub. No.: US 2002/0107833 A1
(43) Pub. Date: Aug. 8, 2002

(54) Method and system for tracking equipment usage information

(76) Inventor: Fuat J. Kerkinni, Lakeville, MN (US)

Correspondence Address: Daniel G. Chapik, DORSEY & WHITNEY LLP, Suite 1500, 50 South Sixth Street, Minneapolis, MN, 55402-1498, US

(21) Appl. No.: 09/991,551

(22) Filed: Nov. 16, 2001

Related U.S. Application Data
(63) Continuation of application No. PCT/US00/41617, filed on Oct. 26, 2000.
(60) Provisional application No. 60/162,396, filed on Oct. 29, 1999.

(51) Int. Cl. G06F 7/00

(52) U.S. Cl. 707/1

(57) ABSTRACT

The present invention relates to a method and system for receiving, storing, compiling and reporting usage information for equipment such as leased vehicles, automobiles, construction equipment. The method may include the use of a server, a communication pathway, a user interface device, and a database.

### 1. FIELD

This invention relates to electronically tracking and reporting usage information. More particularly, this invention relates to a new method and system for an administrator to receive, store, compile, and report usage information, such as miles driven for a leased vehicle. The method and system may use the Internet or telephone interactive voice response systems.

### 2. BACKGROUND

When an individual leases a vehicle through his/her employer, the vehicle may be used for business as well as personal travel. When the vehicle is driven for personal use, it might give rise to a taxable event. Keeping track of the personal distance driven versus the business distance driven is required so that the individual using the vehicle can properly report the usage information to the Internal Revenue Service (“IRS”). The IRS may also be interested in information such as the total distance driven and how much the individual has spent on maintenance for the vehicle. The out-of-pocket maintenance expenses might allow a person to take a credit for the money spent, setting off the money owed for personal use of the vehicle.

Although automobiles are common items for which usage information may be important, tracking usage information may also be important for other pieces of leased equipment. Although tracking personal usage information might not be an important issue for other types of equipment, such as construction equipment, tracking usage information in terms of hours of use may be desirable. For example, hours of use may be used to determine maintenance schedules or replacement schedules, and other usage characteristics may be important for a number of other purposes as known to those skilled in the relevant fields.

The task of keeping track of the personal distance driven, business distance driven, and other related information has traditionally been done through the mail. The company leasing the vehicle sends to the individual using the vehicle a postcard for the individual to fill out. The lessor fills out by hand the pertinent information regarding the usage information, such as the distance driven, whether the party has done any maintenance on the vehicle, and any other information that the leasing company wishes to track. This postcard is then sent to the leasing company. When the leasing company receives the postcard the information may be entered into a database system. Entering the information into the database system may be a labor intensive operation involving workers sorting the postcards and entering the usage information into the database. Reports of usage information may be generated on a regular basis and sent to the individual with the equipment to keep the individual updated on the pertinent information.

The prior art process for tracking usage information has a number of problems. It is time consuming, expensive, and tedious to mail information and to manually enter usage information in order to track usage. In addition, individuals are not always on time when it comes to regularly supplying usage information, and the process of mailing and filling out information by hand can be tedious for individual lessors. Furthermore, the leasing company may encounter a labor intensive process in sorting and entering usage information into tracking systems. Errors occur when the usage information is not written clearly or when the data entry staff misreads the information. Furthermore, if an individual customer wishes to request a report outside of the regular reporting cycle, then that person must request the report from the leasing company, which typically involves talking to a live person. These steps take time for both the individual customer and the administrator (or leasing company). A more reliable and more efficient system is needed that reduces processing costs for the leasing company and is easier for the individual lessor to use.

### SUMMARY

One embodiment of the invention is a method and system for tracking usage information by an administrator for equipment. The administrator for the equipment may electronically solicit personal usage information and business usage information for a specified period from a client. The usage information may be tracked in monthly increments, quarters, or over whatever time period the administrator desires. This usage information can be in the form of personal distance driven, business distance driven, total distance driven, sums spent on equipment maintenance, and a variety of other variables. The administrator then electronically receives and stores in a server database the usage information for the equipment, processes the information, and generates a report for the information.

A report may be generated for a specified period using the usage information for that specified period. This report can be compiled as soon as the information is entered and then continually updated each time new information is entered. When the individual customer requests a report, then it is ready to be immediately sent out. Alternatively, the usage information can just be stored in a ready to compile format. The usage information may then be compiled into a reportable format upon request or at a regular interval for reporting.

One advantage of the invention is that it decreases the amount of administration time and money spent by the system administrator in tracking usage information. In addition, it is convenient and may save time for the user who reports the information. The administrator does not have to deal with a large number of usage information postcards that may need to be sent, collected, and then entered into a database. Furthermore, the user can enter in the usage information whenever it is convenient. The method and system of the invention may also decrease errors due to decreased human involvement in the reporting system.

In one embodiment of the invention, the system and method may be used to track personal mileage and business mileage for leased vehicles. A report may then be generated that specifies the taxable benefit (or income) to the driver of the leased vehicle based on the personal use of the vehicle. This report may be automatically generated so that it saves the user a significant amount of time in reporting information to the IRS for tax purposes.

### DESCRIPTION OF THE DRAWINGS

FIG. 1 is a block diagram overview of a client server system in which the present invention functions;

FIG. 2 is a block diagram of the hardware of a client interface of FIG. 1;

FIG. 3 is a block diagram of the hardware of a client interface of FIG. 1;

FIG. 4 is a block diagram of the server side database;

FIG. 5 is a block diagram of the steps taken for a user to log onto the system and input usage information into the server database;

FIG. 6 is a block diagram showing how usage information can be compiled and reported;

FIG. 7 is a block diagram showing how usage information can be compiled and reported;

FIG. 8 shows an example of a welcome to the server system screen for use with the Internet access;

FIG. 9 shows an Internet version of the user log in screen;

FIG. 10 shows a report of usage information; and

FIG. 11 shows an Internet page in which a user can enter in new usage information.

### DETAILED DESCRIPTION

One embodiment of the invention allows a user to access a remote database and enter usage information for a reporting period for a piece of equipment. If the piece of equipment is a leased vehicle, for instance, the user may enter personal miles driven and business miles driven into the database for a specified period, such as for a one month period. This information may then be totaled and compiled so that reports may be generated for a reporting period. If, for instance, the invention is to be used to compile personal miles driven and business miles driven for a leased vehicle, a report may be generated at the end of a year so that the user may use the reported information for tax purposes. In other embodiments, the method and system of the invention may be used to keep track of maintenance concerns for a piece of equipment in order to notify the user when certain maintenance procedures may be performed. If the piece of equipment is construction equipment, for instance, the user may enter hours of use for a specified period. A report may then be generated at the appropriate time to notify the user of the need for a particular maintenance procedure.

The teachings of the present invention are applicable to many different types of computer networks and may also be used, for instance, in conjunction with direct on-line connections to databases. As will be appreciated by those of ordinary skill in the art, while the following discussion sets forth various preferred implementations of the method and system of the present invention, these implementations are not intended to be restrictive of the appended claims, nor are they intended to imply that the claimed invention has limited applicability to one type of computer network. While the principles underlying the Internet and the Web are described in some detail below in connection with various aspects of the present invention, this discussion is provided for descriptive purposes only and is not intended to imply any limiting aspects to the broadly claimed methods and systems of the present invention.

The Internet is widely used today for a variety of applications. The Internet is a collection of computer networks that allows computer users to share files and other computer resources. Each computer connected to the Internet has a unique address whose format is defined by the Internet Protocol (“TCP/IP”). The Internet includes a public network using the TCP/IP and includes two kinds of computers: servers, which provide information and documents; and clients, which retrieve and display documents and information for users. As will be appreciated by those of ordinary skill in the art, as used throughout this specification the term “client” refers to a client computer (or machine) on a network, or to a process or programs, such as Web browsers, which run on a client computer in order to facilitate network connectivity and communications. This specification will use the term “individual” or “user” when referring to a person using a client computer to access the server and enter usage information. Similarly, the term “server” will be used throughout this specification to refer to a server computer or computer system on a network, including the database attached to the server for storing information.

The “World Wide Web” (“Web”) is that collection of servers on the Internet that utilize the Hypertext Transfer Protocol (“HTTP”). Upon login, HTTPS is used, which is an encrypted, secure version of HTTP. HTTP is a known application protocol that provides users access to resources, which may be information in different formats such as text, graphics, images, sound, video, Hypertext Markup Language (“HTML”), as well as programs. HTML is a standard page description language which provides basic document formatting and allows the developer to specify “links” to other servers and files. Links may be specified via a Uniform Resource Locator (“URL”). Upon specification of a link by the user, the client makes a TCP/IP request to a Web server and receives information, which may be another “Web page” that is formatted according to HTML. Users can also access other pages on the same or other servers by following instructions on the screen, entering certain data, or clicking on selected icons.

Servers run on a variety of platforms, including UNIX machines, although other platforms, such as Windows 95, Windows NT, and Macintosh may also be used. Computer users can view information available on servers or networks on the Web through the use of browsing software, such as Netscape Navigator, Microsoft Internet Explorer, Mosaic, or Lynx browsers. A typical Web page is an HTML document with text, “links” that a user may activate (e.g. “click on”), as well as embedded URL's pointing to resources, such as images, video or sound, that the client may activate to fully use the Web page in a browser. Furthermore, icons may be present which a user clicks on to submit usage information to the server, or to request information from the server. In some situations, these resources may not be located on the same server that provided the HTML document to the client. Furthermore, HTTP allows for the transmission of certain information from the client to a server. The server can then post this information on its web site, forward it on to another user or server, or save it to a database for later use.

Telephone interactive voice response systems (“IVR”) may also be used for accessing and listening to information stored in a database. The IVR systems use computer software and voice recognition programs to run the system. Currently, many credit card companies, among other businesses, use IVR systems for customer service functions. In these systems a user may access the system using a 1-800 number or other number to place the call through a standard touch-tone telephone. Once dialed in, the user may be asked to touch or speak an identification code and a password. The identification code can be in words represented by the letters on the telephone keys, or simply numbers. Once the password and identification is accepted, an automated voice will ask the user what information the user would like to access or what type of function the user would like to perform. Prompting the user may be done by asking the user to touch or say a number corresponding to the desired choice. The user may then make a selection and may be further prompted to listen to the requested information or to enter new usage information. The IVR user can enter information using the telephone keypad or by speaking. This information may be read back by the IVR system in order to prompt the user to confirm that the information was correctly entered and understood by the database system. Once the IVR use has finished using the IVR system, the IVR user can log off the system by pressing a certain number on the keypad, saying the number aloud, or simply hanging up.

The accompanying Figures depict features and components of the methods and systems of the present invention. With regard to references in this specification to computers, the computers may be any standard computer including standard attachments and components thereof (e.g., a disk drive, hard drive, CD player or network server that communicates with a CPU and main memory, a sound board, a keyboard and mouse, and a monitor). The processor of the CPU in the computer may be any conventional general purpose single- or multi-chip microprocessor such as a Pentium® processor, a Pentium® Pro processor, a 8051 processor, a MIPS® processor, a Power PC® processor, or an ALPHA® processor. In addition, the processor may be any conventional special purpose processor such as a digital signal processor or a graphics processor. The microprocessor has conventional address lines, conventional data lines, and one or more conventional control lines. With regard to references to software, the software may be standard software used by those skilled in the art or may be coded in any standard programming language to accomplish the tasks detailed below.

The telephone interactive device for an IVR system can also come in a variety of forms which are commonly used in the art. These telephone systems may have an audio output device, a microphone into which the user can speak, and a keypad on which the user can enter numbers. Some of these phones will be connected to a base which is then connected to a conventional land line through a standard telephone jack. Other phones may have no connection to the base, or even no land line connection.

A. General Overview

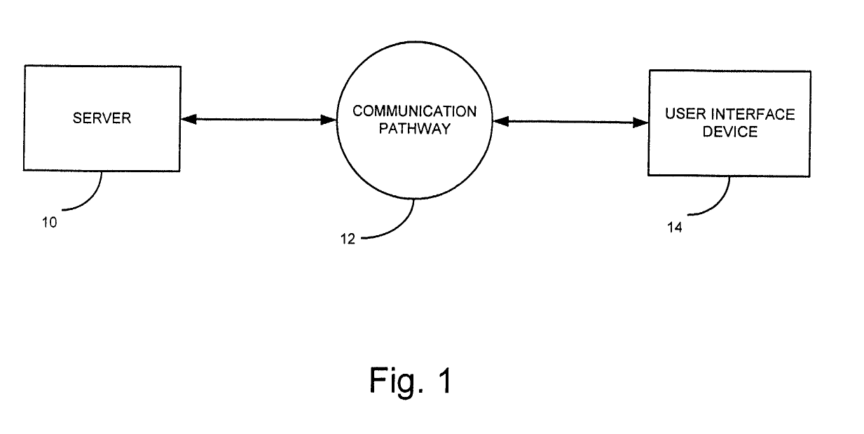

FIG. 1 is a block diagram illustration of the environment of one embodiment of the present invention, which is a network based on a client-server model. The network comprises one or more servers 10 which are accessible by one or more user interface devices 14, such as personal computers or telephones. FIG. 1 illustrates a user interface device 14, which may be either a client computer, a touch tone telephone, or another interface device known to those skilled in the art. The servers 10 communicate with the user interface device 14 over a communication pathway 12, which may be a direct dial connection, the Internet or other suitable telecommunications path. A suitable network protocol, such as the TCP/IP protocol, may be used for the communications. For an IVR system, communications may be done by voice interactive technology known in the art or by pushbutton commands. The servers 10 may comprise Web servers and application servers, and may be any computer known to those skilled in the art. The Web server and the application server can be separate entities, or may exist within a single computer or computer system. This specification will refer to both possibilities as server 10. The server 10 allows access by the user interface devices 14 to various network resources.

1. The Client-Side

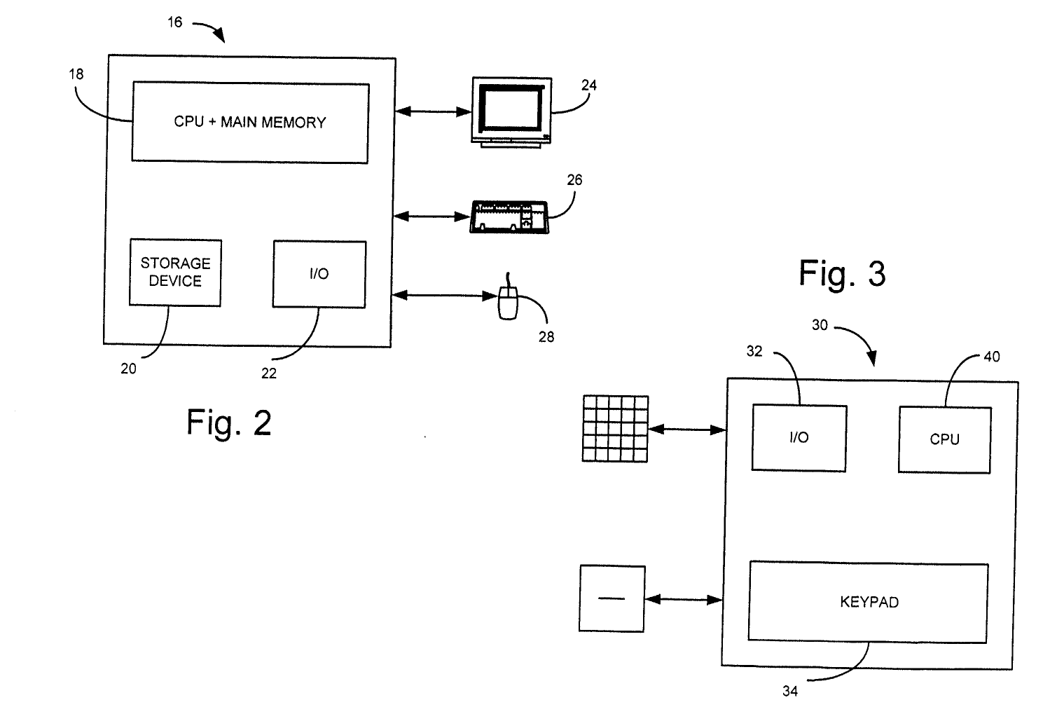

FIGS. 2 and 3 show two different embodiments of a user interface device 14 that may be used within the scope of the invention. As described above, the client's user interface device 14 may be any conventional computer known to those skilled in the art or may also be a standard telephone. FIG. 2 shows the basic layout of a client computer 16 as a user interface device 14 and FIG. 3 shows the basic construction of a telephone 30 as a user interface device 14.

In FIG. 2, the client computer 16 comprises a central processor unit (“CPU”) and main memory 18, an input/output interface 22 for communicating with various databases, files, programs, and networks (such as the Internet), and one or more storage devices 20. The storage devices 20 may be disk drive devices or CD ROM devices. The client computer 16 may also have a monitor 24 or other screen device and an input device such as a keyboard 26 or a mouse 28. In order to carry out the present invention over the Internet, the client computer 16 may also have some software programs contained in the main memory 18 or the storage devices 20 which can be used by the CPU 18.

In one embodiment of the present invention, a Web browser, which is a known software tool used to access the Web via a connection obtained through an Internet access provider, may be part of the software programs on the client computer 16. A variety of browsers known to those skilled in the art may be used within the scope of the present invention, including Netscape Navigator, Microsoft Internet Explorer, or Mosaic browsers. As explained above, a Web server may allow access to so-called “Web sites” and “Web pages.” Once the Web browser has accessed these pages through the Web server, the HTML page may be downloaded through the input/output interface 22. The central processing unit 18 may use the browser software package to interpret the information and display it on the monitor 24. The software programs on the client computer 16 may also contain other software or programs which will allow the user to fill in information on the screens and to exchange data with the server 10.

The telephone for use in an IVR embodiment of the invention is represented in FIG. 3. The telephone 30 has an input/output device 32 which allows it to receive and send information over the telephone communication system. The telephone 30 may also have a keypad 34 that allows the user to enter phone numbers, letters, or numbers. As is known in the art, this keypad 34 can take many different sizes and shapes, but normally will contain ten digits and two symbols. The telephone may also have a speaker 36 that allows the user to hear the spoken information. The spoken information is transferred over the telephone system through methods known in the art and interpreted by the telephone's CPU 40 into speech that comes out of the speaker 36. The user also may input information by voice through a microphone 38. For the IVR system that this invention may employ, the client can use either the keypad 34 or the microphone 38 to enter information.

2. The Server-Side

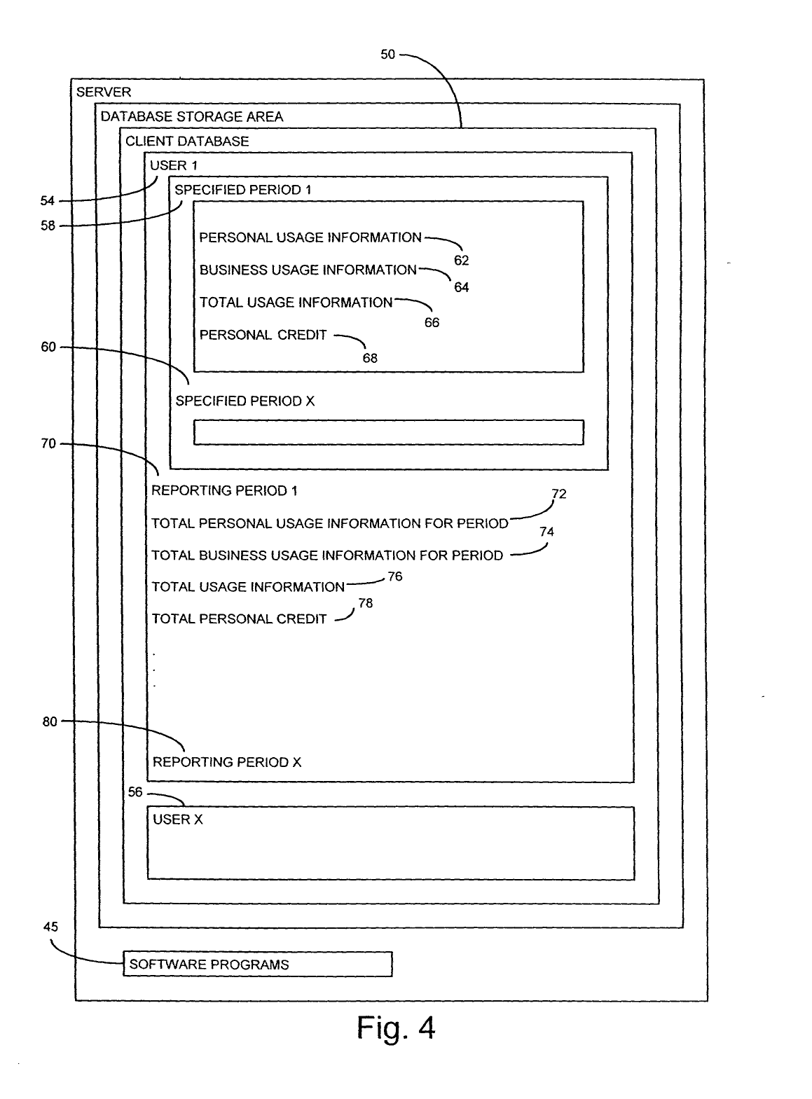

FIG. 4 shows a possible server configuration for the system of FIG. 1. The server 10 contains software programs 45 that run on the server-side to process requests and responses from the user's interface. In addition, the software programs 45 may send information to the client, perform compilation and storage functions, and generate reports that may be used by either the client or the system administrator. If the Internet is the user's interface, then the server 10 may also send web pages in HTML format for the user to download and interpret with his/her computer and view on a monitor. If the user utilizes the IVR format, the server 10 may send responses in the form of automated speech.

The server 10 may be set up in a variety of different formats to perform the functions of the invention. One possible format is shown in FIG. 4, although other formats may also be used within the scope of the invention. The server 10 may be set up to incorporate a client database 50 in a database storage area 52, or the server 10 may simply be connected to a client database 50 at a remote site in much the same way as the server 10 and user interface devices 14 are connected. The client database 50 may include information on a variety of clients, two of which are shown as User 1 (numeral 54) and User X (numeral 56) in FIG. 4.

The server 10 may be separated into software programs 45 and database storage areas 52, which contain the client databases 50. As noted above, the storage areas 52 can be incorporated into the same system as the server 10, or the server 10 may be remotely connected to the client database 50. The database storage area 52 of the system may be further broken up by client and also by piece of equipment. If, for example, the invention is used to track miles for leased vehicles, a given client may have a large fleet of vehicles with each vehicle being driven by a different driver. The database structure of the server 10 may, therefore, be structured such that a number of vehicles corresponding to different drivers may be included in a given folder for a client within a database. For simplicity, FIG. 4 depicts two users, User 1 (numeral 54) and User X (numeral 56), which may correspond to different vehicles in a vehicle tracking embodiment of the invention.

FIG. 4 depicts two specified periods, specified period 1 (numeral 58) and specified period X (numeral 60). Each specified period 58, 60, of which any number may exist in the server 10, refers to a period for which a user would commonly report usage information, such as a period of one week or one month. Within each specified period 58, 60, various types of information may be stored, such as personal usage information 62, business usage information 64, total usage information 66, and personal credits 68. For each specified period 58, 60, therefore, the user may enter these types of information. Personal usage information 62 may, in one embodiment, refer to personal miles driven for a leased vehicle; business usage information 64 may refer to business miles driven; total usage information 66 may refer to the sum of personal and business usage information 62, 64; and a personal credit may refer to money spent by the user for maintenance for a vehicle during the specified period 58, 60. A variety of other types of information may also be included within the specified periods 58, 60, such as an ending odometer reading for a vehicle, a beginning odometer reading for a vehicle, or any other type of information for which tracking may be desirable.

A reporting period, as represented by numeral 70 and 80 in FIG. 4, may refer to a period for which a report may be generated. For instance, a yearly report or monthly report may be generated by totaling the information in for the specified periods 58, 60. Numerals 72, 74, 76, and 78, therefore, may simply be the total of the information for the specified periods 58, 60.

B. Operation of the Invention

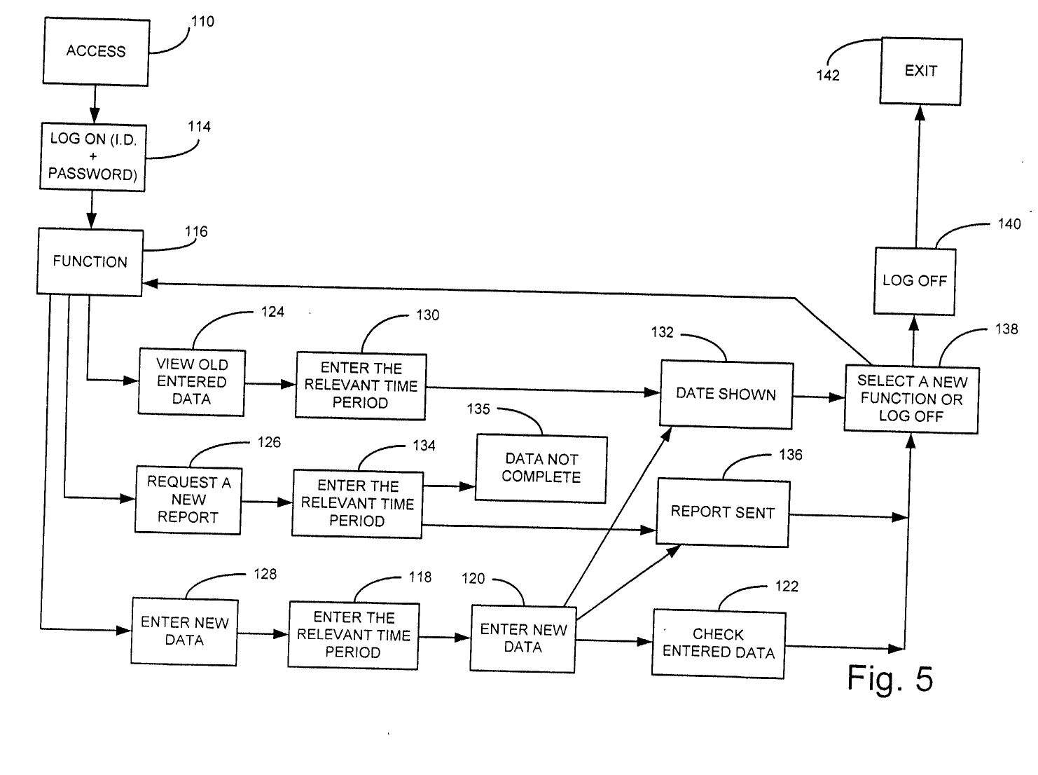

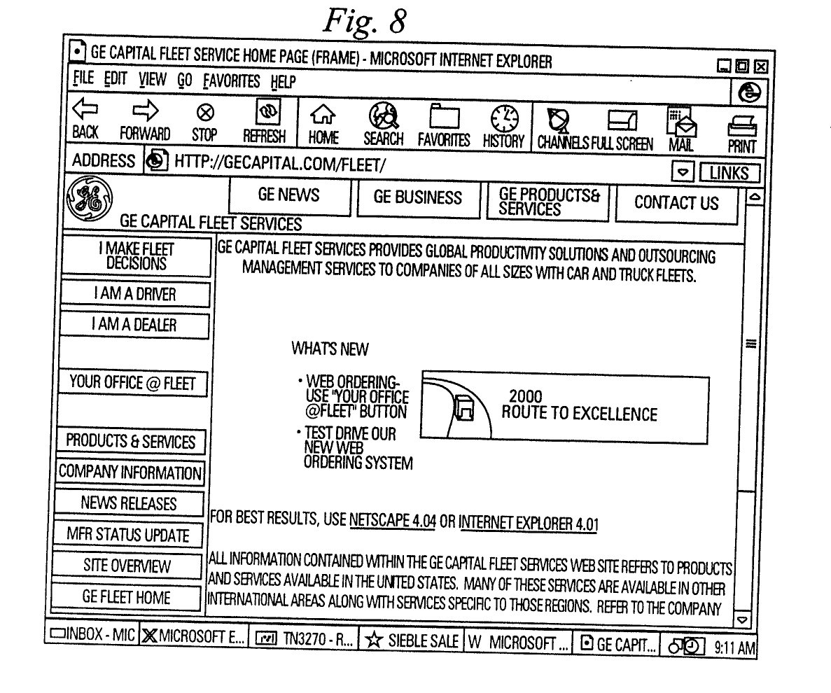

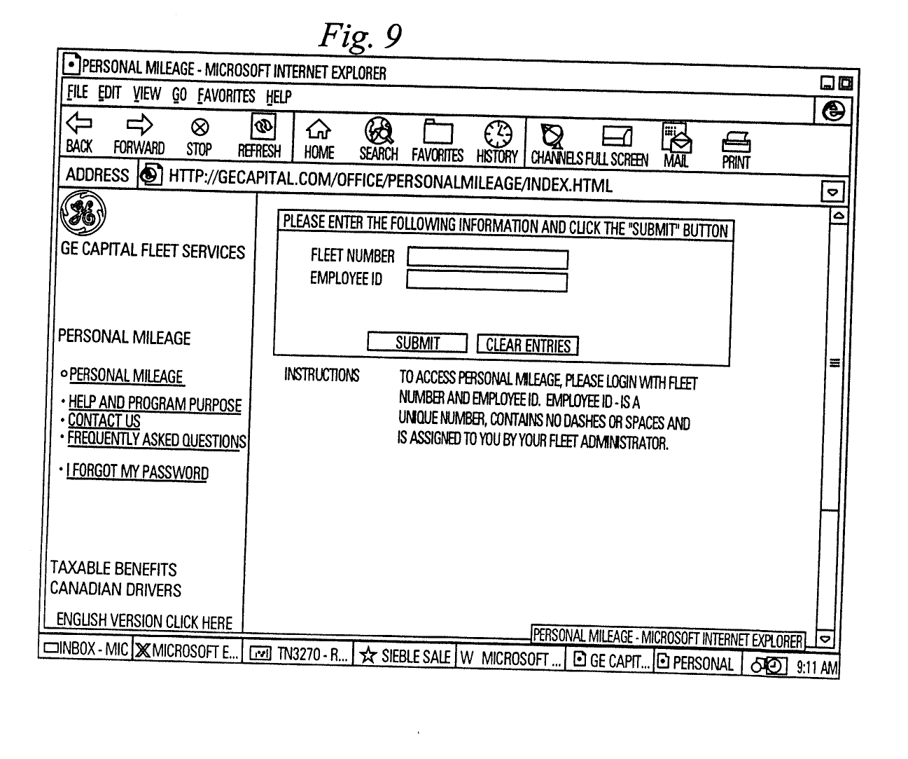

FIGS. 5-7 illustrate flow diagrams of the operation of one embodiment of the invention. FIG. 5 shows a block diagram of the acts of logging onto the system and inputting usage information into the server database. FIG. 5 will be described in terms of an Internet embodiment of the invention, although this flow diagram is equally applicable to an IVR embodiment of the invention. The individual customer may access 110 the Internet application by typing in the appropriate TCP/IP address and downloading the HTML formatted web page. The user may first be directed to a welcome page, one embodiment of which is shown in FIG. 8. Alternatively, a user may access 110 the IVR application by dialing in using a standard telephone. Once the connection is made, the user may need to log on 114 to the database server 10. To log on 114 to the database, the user may be prompted to enter an identification and a password 114. One embodiment of an identification and password Web page for the Internet is shown in FIG. 9. After the user logs into the database, the user may begin to access or enter information. The server database may prompt the user to select a function 116 for which the user wishes to work with. The user may select to review previously entered data 124, request a report 126, or request to enter new data 128.

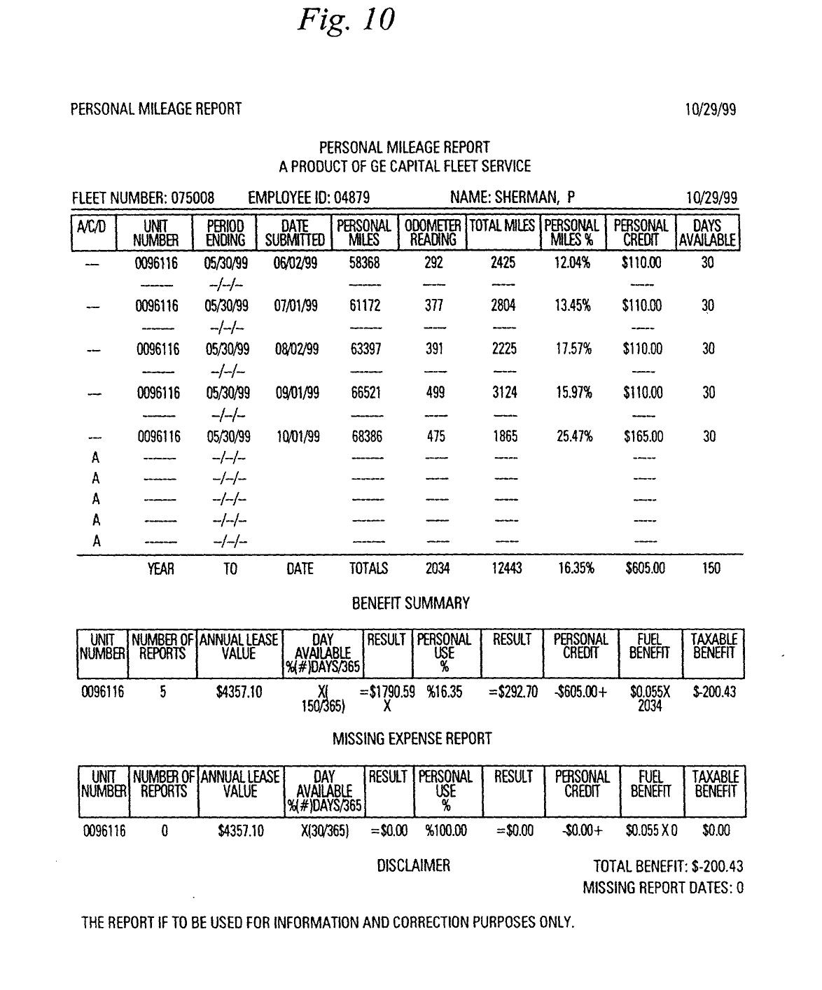

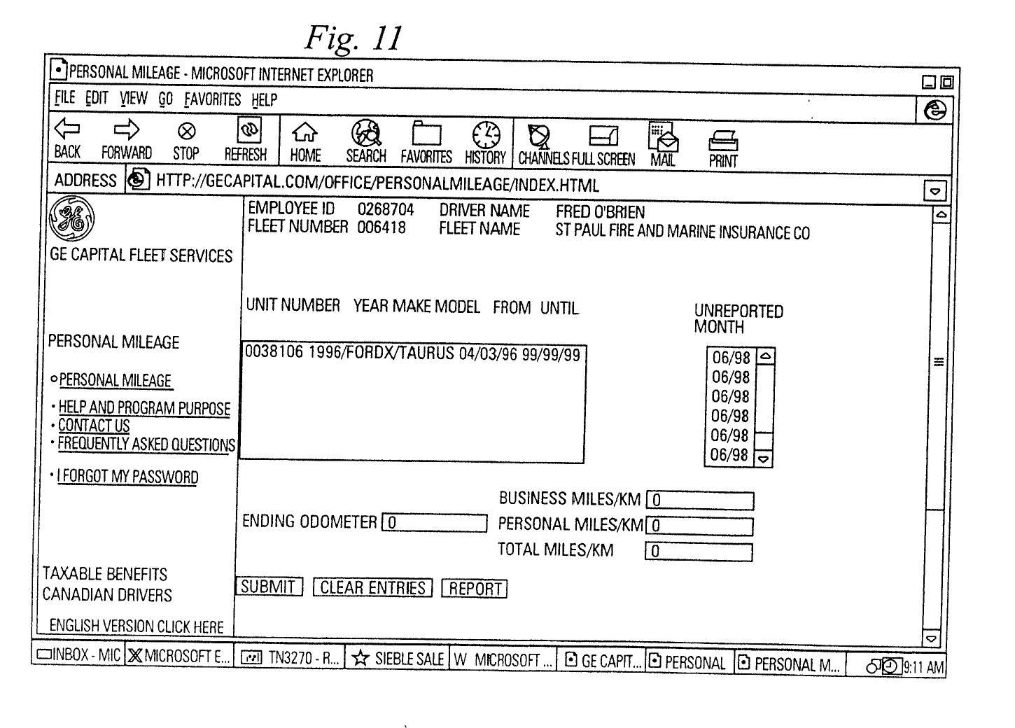

If the user decides to review previously entered data 124, the user may enter 130 a specified period for which to review the usage information. The server database may then recall the usage information and display the usage information to the user 132 in an embodiment such as that shown in FIG. 10. If the data for the selected time period has not been completely entered, the server database system may prompt the user to enter the remaining data 120 for any number of specified periods. In an Internet embodiment of the invention, the information may be downloaded and displayed 132 on the user's computer using an HTML file. In a IVR embodiment, the data may be spoken by the computer, one field at a time. FIG. 10, for instance, depicts an embodiment in which the invention is used for reporting personal and business miles for a leased vehicle. Information in each of the fields depicted in FIG. 10 may therefore be displayed in one embodiment of the invention. FIG. 10 shows such information as the odometer reading of the vehicle, personal miles, total miles, percent personal miles, personal credits, and the beginning and ending dates of the reporting period.

The user may make the appropriate selection from the menu of options to request a report 126. The user may have to enter information for each specified period 134 for which the report is requested. If all of the relevant usage information has not been entered for the requested reporting period 135, the user may be prompted to enter the new usage information 120 before the report can be properly compiled and the information reported 136. Once the software programs of the server database have confirmed that all of the usage information has been entered for a given reporting period, then the report may be printed and sent to the client, or, in other embodiments, the report may simply be spoken to the user or downloaded to the client computer so that the user can view the information.

If the user desires to enter new data 128 for a given specified period or reporting period, the server database may first prompt the user to select a relevant specified period 118 for usage information entry. The usage information may be entered in any unit that is appropriate for the type of information. If, for instance, a vehicle mile reporting embodiment of the invention is used, the usage information may be entered in miles for individuals in the United States or in kilometers for individuals in other countries. In an Internet version the server database may then display blank fields 120 on a new web page in which the user may enter the usage information 120. FIG. 11 shows an example of how the user can input business distance, personal distance, total distance, and the ending odometer reading in a vehicle mile reporting embodiment of the invention. Drop-down boxes or other types of information entry applications known to those skilled in the art may also be used for entry of usage information. FIG. 11 also shows other information that may be displayed in one embodiment of the invention, including the type of vehicle for which the individual is entering usage information, what specified periods or reporting periods need information entered, and the company to which the vehicle is leased. FIG. 11 also shows various buttons that may be used within the scope of the invention, such as a submit button, a clear entries button, and a report button. In addition, FIG. 11 shows information on the user of the vehicle, the company leasing the vehicle, and other information. In an IVR version the server database may prompt the user to enter a given field, and then move on to the next given field after the user has entered usage information, or at the direction of the user.

The invention may be set up to automatically verify the accuracy of the entered information. In a mile reporting embodiment of the invention for leased vehicles, for instance, the system may verify the accuracy of entered information by simply assuming that certain distances (such as 2500 miles, 5000 miles, or 10,000 miles) are typically not driven in a one month period. If such a number is entered by a user for personal miles or business miles, the system may ask the user to verify that such a number is accurate or, alternatively, may simply not allow the user to enter such a number. In addition, the system may require the user to enter the ending odometer distance for each reporting period. If the user attempts to enter a distance driven that is larger than the difference between an odometer reading at the end of a month minus the odometer reading at the end of the previous month, the software programs of the system can assume that an incorrect number has been entered. Logic may therefore look at the ending odometer readings to determine if entered usage information has been properly entered. A number of other logic features to prompt the user to enter certain information or specify that certain information appears to be incorrect may be incorporated into the invention.

After usage information has been entered, it may be used for a number of applications, such as for maintenance schedules or tax reporting purposes. In an embodiment of the invention for mile reporting, a report may be generated that is useful for tax reporting purposes of personal miles driven and business miles driven. Another feature of the invention may include automated prompting for a user to enter information. For instance, if a user has not entered information for a given specified period, such as the month of January, the system may prompt the user to enter information for that month by either sending an email reminder to the user, leaving a telephone message for the user, or using a reminder window on a Web page to remind the user of the need to enter information for a given specified period.

FIG. 10 shows an example of a report generated for an embodiment of the invention used for tax reporting purposes for leased vehicles. FIG. 10 shows a number of columns that include information for monthly periods on odometer readings, personal miles driven, total miles, percent personal miles, a personal credit, and the days that the car was available to the user. The bottom portion of FIG. 10 shows a report of the usage information that has been used to generate information for tax purposes, namely a taxable benefit. The taxable benefit is essentially the amount of money that is considered non-cash compensation to the driver and that may be included on a W2 tax form in the United States. In one embodiment, such as that shown in FIG. 10, the user may change reported information by typing, printing, or entering information on the lines below the reported information for each period. This information may then be updated and the reported modified accordingly.

The summary in FIG. 10 illustrates the number of specified periods (or months) for which the report has usage information (for the five periods at the top of FIG. 10). The report uses an annual lease value (value of the lease over a year-long period). This annual lease value is then multiplied by the number of days for which the vehicle has been used by the driver (150 in FIG. 10) to come up with a result which is the value of the leased vehicle over the period of usage. This value is then multiplied by the percent of personal use of the vehicle to come up with a result, which is the taxable benefit for the vehicle, excluding credits. FIG. 10 also shows a credit of $605.00 (maintenance expenses) and a fuel benefit (amount spent on fuel per mile multiplied by the number of miles the vehicle was driven). The fuel benefit uses a standard benefit value of 5.5 cents per mile, although this number may be altered, and is simply an approximated number used for tax purposes.

FIG. 10 also calculates the taxable benefit of the leased vehicle if miles were not reported for a given period (which may be a given month for which usage information was not entered). In this instance, the report may simply assume that the vehicle was used solely for personal use and may increase the taxable benefit accordingly. If usage information for all time periods has been reported, the number of reporting periods with missing data will be 0 and no additional taxable benefit will result. FIG. 10 indicates a taxable benefit over a 5-month period of −200.43, which indicates that the driver of the vehicle has no taxable benefit over this time period. In addition to the calculations shown on FIG. 10, such a report may also show maintenance schedules, replacement schedules, and other information which depends on the distance the vehicle has been driven and/or the time during which the vehicle has been in use.

Referring again to FIG. 5, once the usage information is displayed 132 the report requested 136, or the usage information entered 120, the user may then go back to the beginning to perform other operations. To go back to the beginning, the user may simply select the appropriate menu option 138. Alternatively, the user can exit the database 134.

To exit the system 142, the Internet version user may first log off 140 the server database. Logging off 140 may ensure that if the computer is left on and connected to the server database, another user or passerby could not alter the previously entered usage information or enter incorrect usage information. To log off 140 the IVR system, the user may select the proper key corresponding to the correct menu item, say the number corresponding to the correct menu item, or simply hang up. Once the user has logged off 140 and exited 142 the system, the server database may compile the information entered.

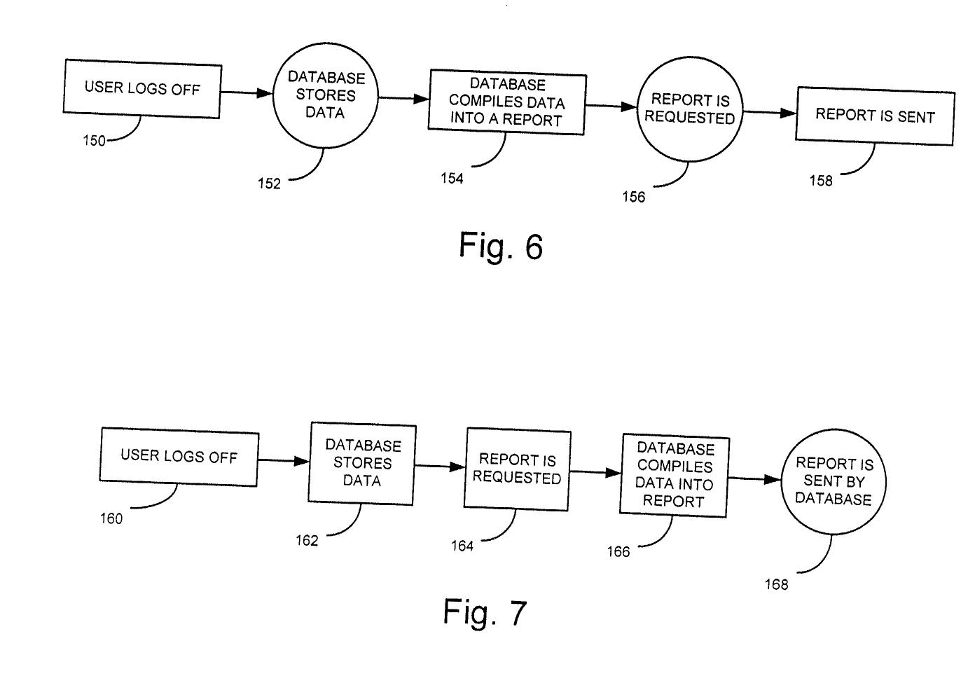

FIG. 6 shows a flow diagram of a method for reporting the usage information. The server database in this diagram may store the entered usage information 152 and also may send a copy to be immediately compiled into a report 154. This report 154 may be updated every time usage information is entered into the system. When a report is requested 156 for a reporting period, the server database may select the appropriate part of the compiled data and may send a report 158 for the reporting period.

FIG. 7 shows another way that the server database may compile reports for reporting periods. As in the embodiment of FIG. 6, the user may have just logged off the system 160 and now the server database must handle the newly entered usage information. The server database may store the database 162 as before, but does not have to send it off to be compiled right away as in FIG. 6. The server database may simply collect the usage information and store the raw data 162. When a report is requested 164 for a reportable period, or the day comes for a regular report to be issued, the server database may compile the usage information into a report 166. This report is then sent 168 to the appropriate party. In this embodiment, the software programs of the server may build a report upon request from a user (or alternatively at intermittent periods).

While the present invention has been described with reference to several embodiments thereof, those skilled in the art may recognize various changes that may be made without departing from the spirit and scope of the claimed invention. Accordingly, this invention is not limited to what is shown in the drawings and described in the specification but only as indicated in the appended claims. Any number or ordering of the elements in the following claims is merely for convenience and is not intended to suggest that the ordering of the elements of the claims has any particular significance other than that otherwise expressed by the language of the claims.

What is claimed is:

1. A method for tracking usage information for equipment, the method comprising:
(a) electronically soliciting from a client personal usage information and business usage information for the equipment for one or more specified periods;
(b) electronically receiving and storing in a server the personal usage information and business usage information for the equipment for the one or more specified periods;
(c) compiling total usage information for the one or more specified periods; and
(d) generating a report for a reporting period by using the information received for the one or more specified periods, wherein the report provides details on total personal usage information and total business usage information for the reporting period.

2. The method of claim 1, further comprising:
(a) providing a field for entering an identification number; and
(b) providing a field for entering a group number.

3. The method of claim 1, wherein the act of electronically receiving the usage information from the client for the one or more specified periods further comprises electronically receiving the information over the Internet.

4. The method of claim 1, wherein the act of electronically receiving the usage information from the client for the specified period further comprises electronically receiving the information through a telephone interactive voice response system.

5. The method of claim 1, wherein the personal usage information and the business usage information relates to hours of use.

6. The method of claim 1, wherein the usage information relates to usage information for leased vehicles.

7. The method of claim 6, wherein the act of electronically receiving the usage information from the client for the specified period further comprises providing separate fields for entering at least one member of a group comprising a current total distance driven, a business distance driven, a personal distance driven, and a client personal credit.

8. The method of claim 7, wherein the act of electronically receiving the usage information from the client for the specified period further comprises electronically receiving from the client at least one member of the group comprising the current total distance driven, the business distance driven, the personal distance driven, and the client personal credit.

9. The method of claim 8, wherein the act of generating a report further includes tabulating the current total distance driven, the total business distance driven, the personal distance driven, and the personal credit for the specified period.

10. The method of claim 9, wherein the act of reporting the processed information for the specified period further comprises reporting the usage information to the client upon demand.

11. The method of claim 9, wherein the act of reporting the processed information for the specified period further comprises reporting the usage information to the client at regular business intervals.

12. A method for tracking usage information for an automobile, the method comprising:
(a) electronically soliciting from a client personal usage information and business usage information for the automobile for one or more specified periods;
(b) electronically receiving and storing in a server the personal usage information and business usage information for the automobile for the one or more specified periods;
(c) compiling total usage information for the one or more specified periods; and
(d) generating a report for a reporting period by using the information received for the one or more specified periods, wherein the report provides details on total personal usage information and total business usage information for the reporting period.

13. The method of claim 12, wherein the act of electronically receiving the usage information from the client for the specified period further comprises providing separate fields for entering at least one member of a group comprising a current total distance driven, a business distance driven, a personal distance driven, and a client personal credit.

14. The method of claim 13, wherein the act of electronically receiving the usage information from the client for the specified period further comprises electronically receiving from the client at least one member of the group comprising the current total distance driven, the business distance driven, the personal distance driven, and the client personal credit.

15. The method of claim 14, wherein the act of generating a report further includes tabulating the current total distance driven, the total business distance driven, the personal distance driven, and the personal credit for the specified period.

16. The method of claim 15, wherein the act of reporting the processed information for the specified period further comprises reporting the usage information to the client upon demand.

17. The method of claim 15, wherein the act of reporting the processed information for the specified period further comprises reporting the usage information to the client at regular business intervals.

18. A method for tracking usage information for equipment using a server, a communication pathway, a user interface device, and a client database, the server including at least one software program, the method comprising:
(a) electronically soliciting from a client personal usage information and business usage information for the equipment for one or more specified periods;
(b) electronically receiving and storing in the client database the personal usage information and business usage information for the equipment for the one or more specified periods;
(c) compiling total usage information for the one or more specified periods; and
(d) generating a report for a reporting period by using the personal usage and business usage information received for the one or more specified periods, wherein the report provides details on total personal usage information and total business usage information.

19. The method of claim 18, wherein the act of electronically receiving the usage information from the client for the one or more specified periods further comprises electronically receiving the information over the Internet.

20. The method of claim 18, wherein the act of electronically receiving the usage information from the client for the specified period further comprises electronically receiving the information through a telephone interactive voice response system.

21. The method of claim 18, wherein the personal usage information and the business usage information relates to hours of use.

22. The method of claim 18, wherein the usage information relates to usage information for leased vehicles.

23. The method of claim 22, wherein the act of electronically receiving the personal and business usage information from the client for the specified period further comprises providing separate fields for entering at least one member of the group comprising a current total distance driven, a business distance driven, a personal distance driven, and a client personal credit.

24. The method of claim 23, wherein the act of electronically receiving the usage information from the client for the specified period further comprises electronically receiving from the client at least one member of the group comprising the current total distance driven, the business distance driven, the personal distance driven, and the client personal credit.

25. A system for tracking usage information for equipment, the system comprising:
(a) a user interface device;
(b) a server adapted to electronically receive from the user interface device, process, and retrieve usage information;
(c) at least one software program resident in the server, the at least one software program executed by a processor to process requests and responses from the user interface device;
(d) a client database for storage of the usage information; and
(e) a communication pathway electronically linking the system server to the user interface device.

26. The system of claim 25, wherein the at least one software program is executed by a processor to send information to a client.

27. The system of claim 25, wherein the at least one software program is executed by a processor to compile and store information.

28. The system of claim 25, wherein the at least one software program is executed by a processor to generate reports.

29. The system of claim 25, wherein the usage information relates to hours of use.

30. The system of claim 25, wherein the usage information relates to usage information for leased vehicles.

31. The system of claim 30, wherein the usage information comprises at least one member of the group comprising a current total distance driven, a business distance driven, a personal distance driven, and a client personal credit.

32. A system for tracking usage information for an automobile, the system comprising:
(a) a user interface device;
(b) a server adapted to electronically receive from the user interface device, process, and retrieve usage information relating to the automobile;
(c) at least one software program resident in the server, the at least one software program executed by a processor to process requests and responses from the user interface device;
(d) a client database for storage of the usage information relating to the automobile; and
(e) a communication pathway electronically linking the system server to the user interface device.

33. The system of claim 32, wherein the at least one software program is executed by a processor to send information to a client.

34. The system of claim 32, wherein the at least one software program is executed by a processor to compile and store information.

35. The system of claim 32, wherein the at least one software program is executed by a processor to generate reports.

36. The system of claim 32, wherein the usage information comprises at least one member of the group comprising a current total distance driven, a business distance driven, a personal distance driven, and a client personal credit.
